(19) United States
(12) Patent Application Publication
(10) Pub. No.: US 2009/0155137 A1
(43) Pub. Date: Jun. 18, 2009

(54) APPARATUS FOR PRODUCING A PLASMA JET

(76) Inventors: Andrej Ignatkov, Wuppertal (DE); Jens Raacke, Mettmann (DE)

Correspondence Address: K.F. ROSS P.C., 5683 RIVERDALE AVENUE, SUITE 203 BOX 900, BRONX, NY, 10471-0900, US

(21) Appl. No.: 12/293,296

(22) PCT Filed: Feb. 17, 2007
(86) PCT No.: PCT/EP2007/001386

§ 371 Date: Feb. 23, 2009

(30) Foreign Application Priority Data
Mar. 16, 2006 (DE) 10 2006 012 100.7

(51) Int. Cl. B01J 19/08

(52) U.S. Cl. 422/186.04

(57) ABSTRACT

The invention relates to an apparatus for producing a plasma jet, having at least one discharge tube through which a process gas flows. According to the invention, electrically conductive discharge protection is provided on at least one discharge tube. The advantages of the invention are, in particular, that parasitic discharges are suppressed, and the thermal loads on the individual components of the apparatus and of the substrate are reduced.

### CROSS REFERENCE TO RELATED APPLICATIONS

This application is the US national phase of PCT application PCT/EP2007/001386, filed 17 Feb. 2007, published 20 Sep. 2007 as WO 2007/104404, and claiming the priority of German patent application 102006012100.7 itself filed 16 Mar. 2006, whose entire disclosures are herewith incorporated by reference.

The invention relates to an apparatus for producing a plasma jet, comprising at least one discharge tube through which a process gas flows.

Such an apparatus comprising a discharge tube is known from the publication by Jungo Toshifuji et al: “Cold arc-plasma jet under atmospheric pressure for surface modification,” Surface and Coatings Technology 2003, pages 302ff and the publication “Workshop Plasmabehandlung und Plasma-CVD-Beschichtung bei Atmosphärendruck” (Workshop on Plasma Treatment and Plasma CVD at Atmospheric Pressure), Dresden, Germany 16 Nov. 2004. The known apparatus comprises a discharge tube made of dielectric material, a first solid electrode extending centrally inside the discharge tube in the longitudinal direction, and a second electrode comprising the discharge tube. The second electrode is configured concentrically, so that the inner first electrode, the discharge tube and the second electrode form a coaxial configuration that has a concentric cross-section and an open end at which the plasma jet is produced. For this purpose, high voltage is applied to the inner, rod-shaped electrode, while the outer electrode is grounded. As a result of the conditions of the electric field, preferably the plasma is ignited at the tip of the inner, rod-shaped electrode. The plasma then spreads in the direction of the process gas flow. During operation with helium, nitrogen or oxygen as process gases, a diffuse plasma jet is formed between the tip of the inner electrode and a substrate which can be processed with the plasma jet. This is “cold” plasma with a relatively low gas temperature ranging from room temperature to no more than several hundred degrees Celsius.

However, if following the ignition of the plasma jet the voltage applied is increased on the known device in order to feed more power, for example to obtain a longer or more intense plasma jet, one will find that with the known device plasma forms on the back of the inner electrode or on the fastening of the inner electrode to which the same potential is applied, namely in the direction opposite from the process gas flow. This additional discharge, which is referred to as parasitic discharge, is not desired because it does not contribute to the jet.

Furthermore, with the known device, a high operating voltage and consequently a high driving voltage may result in a direct plasma connection, which is to say arcing, between the inner electrode and the outer electrode. The plasma is then no longer diffuse and cold, but is found in contracted form in thin streams that have a significantly higher gas temperature. This may result in damage to the apparatus and/or the substrate. Furthermore, the gas hose conducting the process gas may be thermally damaged.

It is therefore the object of the invention to provide an apparatus for producing a plasma jet of the type mentioned above, where the parasitic discharge can be suitably suppressed and no arcing can occur between the first and second electrodes. It is furthermore an object of the invention to reduce the overall thermal loads on the individual components of the apparatus and the substrate by ensuring that only “cold” plasma is produced.

This object is achieved by an apparatus for producing a plasma jet with the characteristics of the first claim. The dependent claims relate to particularly advantageous embodiments of the invention.

The invention is based on the general discovery that the interior of metallic hollow bodies subject to electric voltage is field-free. If, however, a hollow cylinder were selected, which is an obvious step for the person skilled in the art, it would have the disadvantage that the electric field on the edge of the hollow cylinder would extend inside, so that it is possible that a field sufficiently large to ignite the plasma is present in an undesirable location in the gas hose. According to the invention, the metallic mount for the gas hose is therefore configured such that the mount widens conically at a defined angle or also in a different manner, for example in steps, so that the electric field at the axial edge of the mount is considerably smaller than that found on a conventional hollow cylinder with a fixed diameter. In an advantageous further development of the invention, all edges of the mount are rounded to prevent high electric fields.

According to a particularly advantageous further development of the invention, the second outer grounded electrode is no longer mounted directly on the discharge tube, as in the prior art, but instead has a certain radial spacing.

According to a particularly advantageous further development of the invention, an end cap made of dielectric material is provided on the end of the discharge tube. As a result, a more intense plasma jet can be produced, particularly when using noble gases.

According to an advantageous, further modified development of the invention, a filter is provided between the gas hose and the discharge tube. In addition to the above-described advantages of the invention, this also suppresses noise development due to turbulence. This noise development occurs in apparatuses known from the state of the art because the process gas flows directly from the gas supply via a hose or the like into the discharge chamber and the gas flowing around the mount of the inner electrode produces turbulence with the associated noise development.

The invention will be explained in more detail hereinafter with reference to the embodiments that are illustrated by way of example in the figures in which:

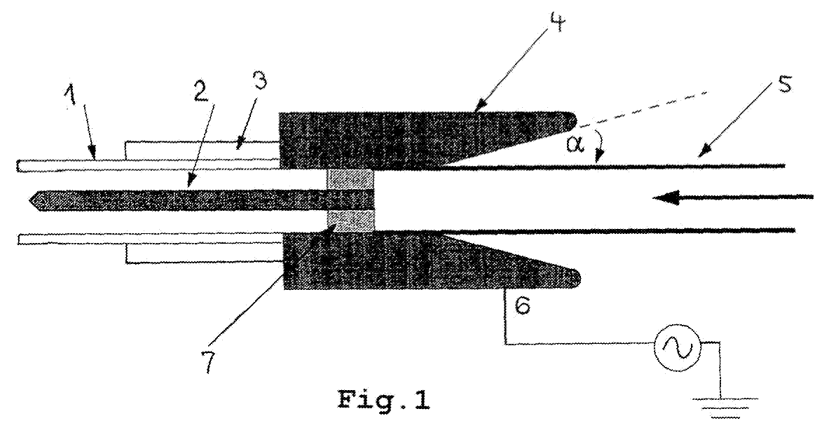

FIG. 1 is a first embodiment of an apparatus according to the invention having a discharge tube

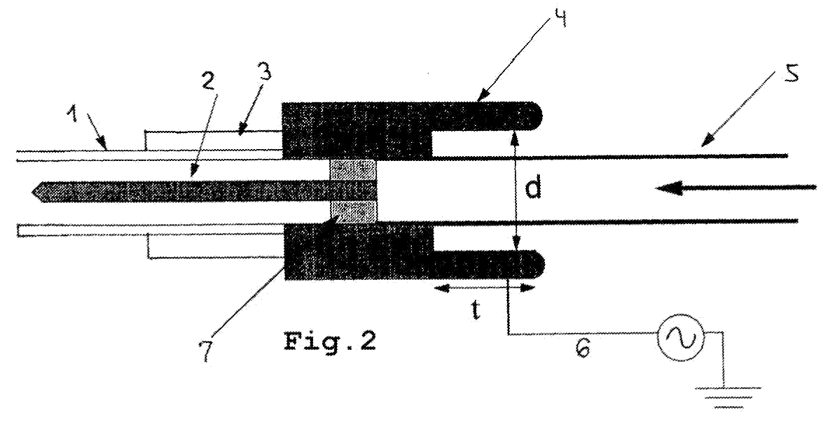

FIG. 2 is a second embodiment of such an apparatus

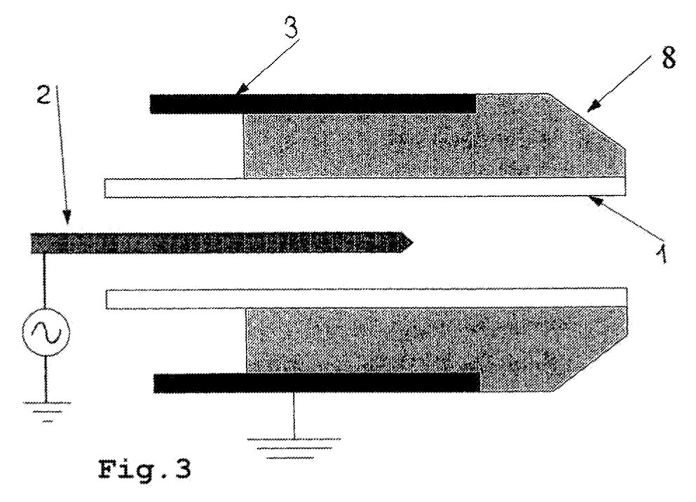

FIG. 3 is a third embodiment of such an apparatus having an added end cap

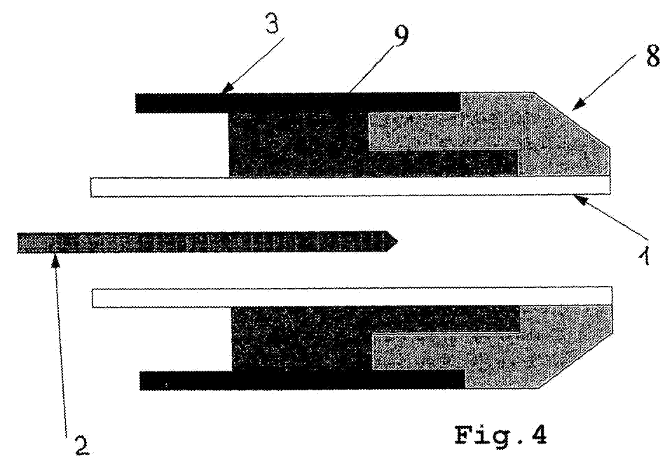

FIG. 4 is a fourth embodiment of such an apparatus having a modified end cap

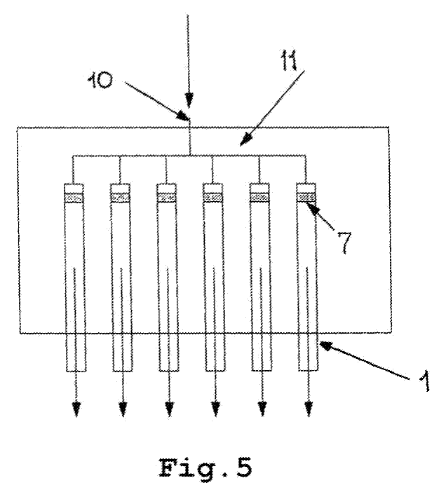

FIG. 5 is a first embodiment of an apparatus according to the invention having a plurality of discharge tubes

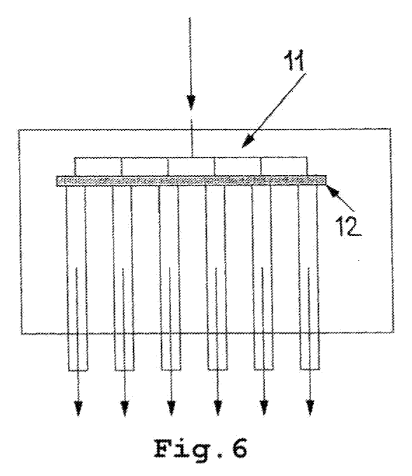

FIG. 6 is a second embodiment of such an apparatus

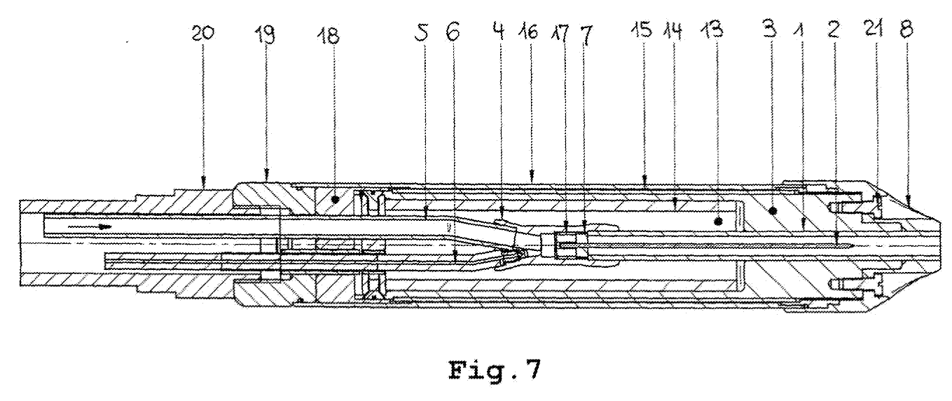

FIG. 7 is a further, commercial embodiment of an apparatus according to the invention having a discharge tube.

The first apparatus according to the invention, which is illustrated schematically in FIG. 1, will be explained in more detail. It comprises a discharge tube 1 made of dielectric material, an inner, rod-shaped, solid electrode 2 provided inside it. A second electrode 3 surrounds the discharge tube 1. This can occur in direct contact or at a radial spacing. This electrode 3 is advantageously configured concentrically, so that the inner electrode 2, the dielectric discharge tube 1 and the outer electrode 3 form a coaxial configuration that has a concentric cross-section and an open end where the plasma jet is produced. For this purpose, high voltage is applied to the inner electrode 1, and the outer electrode 3 is grounded. According to the invention, a metallic discharge shield 4 is provided at the end of the discharge tube 1. In this example, the discharge shield 4 at the same time forms a mount for a gas hose 5 through which the process gas is fed. The direction of flow of the process gas is indicated by an arrow. The discharge shield 4 is a mount and serves as a connection to a high-voltage cable 6. According to an advantageous further development of the invention, a filter 7 made of sintered material is also provided. This filter 7 will be explained in more detail below. The inner electrode 2, which is made of tungsten, for example, is held by the filter 7 and fixed in place in the central position inside the discharge tube 1. In this embodiment of the invention, the discharge shield 4 is configured such that the metallic mount for the gas hose 5 widens conically at an angle α, so that the axial electric field on the edge of the mount is considerably smaller than it would be on a hollow cylinder with a fixed diameter according to the prior art. The angle α depends on the maximum operating voltage as well as the ratio between the diameter of the gas hose 5 and the diameter of the discharge tube 1. It is particularly advantageous to round all edges of the discharge shield 4, particularly in the region of the mount, so as to avoid formation of large electric fields.

The use of the filter 7, as shown in FIG. 1, between the gas hose 5 and the discharge tube 1 suppresses any potential noise development as a result of turbulence. After passing through the filter 7, the gas flow is substantially laminar and stable. In a special embodiment, the filter 7, as also shown in FIG. 1, may be used at the same time as a mount for the inner electrode 2, for example when the filter is made of sintered bronze. Furthermore, pressure builds up upstream of the filter 7 in the direction the flow of the process gas, so this pressure also contributes to the desirable suppression of parasitic discharge since the ignition field strength of the process gas is a function of the prevailing pressure. On the right branch of what is referred to as Paschen's curve, the ignition voltage of a gas increases as the pressure rises. These correlations are known to the person skilled in the art.

FIG. 2 is a second embodiment of an apparatus according to the invention in which the discharge shield 4 is configured differently. In this embodiment, the discharge shield 4 is provided with a bore having a diameter d and a depth t. Also in this embodiment, a considerably smaller axial electric field is therefore formed on the edge of the mount. Within the scope of the invention, further embodiments of the discharge shield 4 are conceivable, for example a stepped widening instead of an angle α.

FIG. 3 shows a further embodiment of an inventive apparatus. Deviating from the prior art, in this example the outer, grounded electrode 3 is no longer mounted directly on the discharge tube 1, but instead at a defined radial spacing therefrom. Furthermore, in this embodiment a dielectric end cap 8 is provided on the open end of the discharge tube 1. The end cap 8 is made, for example, of Teflon or another plastic material with corresponding thermal and mechanical stability, but alternatively it can also be made of ceramic. In a particularly simple manner, the end cap 8 may be fastened to the outer electrode 3 by being screwed on.

The end cap 8 made of dielectric material serves to produce a plasma jet, particularly when using noble gases as the process gases, while feeding relatively low power of typically just a few watts. At the same time, the inventive end cap 8 prevents arcing or arc discharge between the inner electrode 2 and the grounded outer electrode 3 since the spacing between these two electrodes is now considerably larger from an electrical point of view. FIG. 4 shows a further embodiment of the inventive apparatus comprising a modified two-part end cap 8. The outer part is still made of a dielectric, however in addition an inner metallic insert 9 is provided that is electrically connected to the outer electrode 3. This configuration is particularly suited when working with molecular gases as the process gas; the inner metallic insert 9 produces a higher electric field inside the discharge tube 1 and thus also a more intense plasma jet.

Within the scope of the invention, the outer electrode 3 may also be partially surrounded in a different manner by a dielectric material or be completely enclosed by a dielectric material.

FIG. 5 shows a schematic illustration of an embodiment of the invention comprising a plurality of discharge tubes 1, which is referred to as a multi-jet configuration. The figure shows a plurality of parallel discharge tubes 1 that are supplied with the process gas by a supply channel 10 for the process gas and a gas distribution system 11. Such a configuration is likewise known in principle from the prior art. In the known configuration, among a plurality of discharge tubes it would be preferable that the process gas flow through the tube which has the lowest flow resistance or is provided closest to the supply channel 10. Non-uniform process-gas discharge in the state of the art negatively impacts the evenness of the surface treatment of a substrate. In the embodiment shown in FIG. 5, according to an advantageous further development of the invention, as was already explained above, a filter 7 is provided in every discharge tube 7, the filter having significantly higher flow resistance than the flow resistance of the discharge tube 7 itself, resulting in uniform supply of each discharge tube 1 with the process gas; this in turn produces more even individual parallel plasma jets.

FIG. 6 shows an even further modified embodiment of such a configuration where instead of individual filters a larger common filter panel 12 is provided in front of the individual discharge tubes 1.

While the above-described FIGS. 1 to 6 are schematic illustrations of the most important parts essential to the invention, FIG. 7 shows a complete overall drawing of a commercial apparatus according to the invention. In addition to the components already explained above, here also an annular plastic insulator 13 is shown that surrounds the discharge tube 1. A protective tube 14 made of ceramic surrounds this insulator 13. Protective insulation 15 made of plastic surrounds the outer electrode 3. A round metallic housing 16 forms the outer casing. In the embodiment illustrated here, a special electrode holder 17 made of metal is provided on the filter 7 as a separate component. At the back end, the apparatus also comprises an end cap 18 made of plastic, to which an end piece 19 made of metal is connected. A threaded connection 20 is screwed into the end piece 19, both the gas hose 5 and the high-voltage cable 6 being routed through this connection. At the open front end of the apparatus, plastic screws 21 are shown that are used to fasten the end cap 8, in this example to the outer ring-shaped electrode 3.

1. An apparatus for producing a plasma jet, the apparatus comprising:
at least one discharge tube through which a process gas supplied via a gas hose flows and having a wall made of dielectric material,
a first electrode having a solid configuration and oriented such that it extends centrally inside the discharge tube in the longitudinal direction thereof,
a second axially extending electrode concentrically surrounding the wall of the discharge tube such that the first electrode, the discharge tube and the second electrode form a coaxial configuration that has a concentric cross-section and an open end at which the plasma jet can be produced, and
a discharge shield made of electrically conductive material mounted on the discharge tube, the shield being connected to the first electrode such that the discharge shield receives the free end of the gas hose and that the end of the discharge shield facing the free end of the gas hose widens such that the shield surrounds the gas hose while forming a chamber.

2. The apparatus according to claim 1 wherein the end of the discharge shield facing the free end of the gas hose is conically widened at an angle α.

3. The apparatus according to claim 1 wherein the end of the discharge shield facing the free end of the gas hose is widened by a central bore.

4. An apparatus according to claim 1 wherein the second electrode is set at a radial spacing outward from the discharge tube.

5. An apparatus according to claim 1 wherein on the end of the apparatus where the plasma jet is produced a dielectric, concentric end cap is provided that surrounds the second electrode.

6. The apparatus according to claim wherein the end cap is made of Teflon, another plastic material with corresponding thermal and mechanical stability, or ceramic.

7. The apparatus according to claim 5 wherein the end cap has two parts including an additional, inner metallic insert that is electrically connected to the second electrode.

8. The apparatus according to claim 1 wherein the second electrode is completely or partially enclosed by a dielectric material.

9. An apparatus according to claim 1 wherein on the face of the discharge tube to which the process gas is supplied a filter is provided through which the process gas can flow.

10. The apparatus according to claim 9 wherein the filter is made of sintered material, particularly sintered bronze.

11. An apparatus according to claim 9 wherein if a plurality of discharge tubes are provided each has a respective filter.

12. An apparatus according to claim 9 wherein if a plurality of discharge tubes are provided, they jointly form a single filter panel.
